(19) United States
(12) Patent Application Publication
(10) Pub. No.: US 2022/0414615 A1
(43) Pub. Date: Dec. 29, 2022

(54) INFORMATION PROCESSING APPARATUS, INFORMATION PROCESSING METHOD, AND STORAGE MEDIUM

(71) Applicant: TOYOTA JIDOSHA KABUSHIKI KAISHA, Toyota-shi (JP)

(72) Inventors: Yuta TONE, Nagoya-shi (JP); Yukinori II, Toyota-shi (JP); Tadayuki TANAKA, Nagoya-shi (JP); Naoki ISHIZUKA, Nagoya-shi (JP); Yuichiro YANO, Nagakute-shi (JP); Nariaki AMANO, Nagoya-shi (JP); Yusuke MAEDA, Miyoshi-shi (JP); Kei YAZAKI, Okazaki-shi (JP); Yu HAMADA, Nagoya-shi (JP)

(73) Assignee: TOYOTA JIDOSHA KABUSHIKI KAISHA, Toyota-shi (JP)

(21) Appl. No.: 17/841,888

(22) Filed: Jun. 16, 2022

(30) Foreign Application Priority Data
Jun. 29, 2021 (JP) 2021-107485

(51) Int. Cl. G06Q 10/00

(52) U.S. Cl. CPC G06Q 10/20

(57) ABSTRACT

An information processing apparatus comprises a controller configured to acquire work information indicating details of work to be done on a first vehicle, and determine a first site where the work indicated by the work information is available, based on first data associating details of work that is available with each of a plurality of sites.

### CROSS REFERENCE TO THE RELATED APPLICATION

This application claims the benefit of Japanese Patent Application No. 2021-107485, filed on Jun. 29, 2021, which is hereby incorporated by reference herein in its entirety.

### BACKGROUND

### Technical Field

The present disclosure relates to maintenance of a vehicle.

### Description of the Related Art

A system for supporting maintenance of a vehicle is known.

For example, as a related invention, Japanese Patent Laid-Open No. 2005-053239 discloses an invention related to an inspection reservation system for assigning appropriate staff for inspection and maintenance of a vehicle.

### SUMMARY

An object of the present disclosure is to improve efficiency of work on a vehicle.

The present disclosure in its one aspect provides an information processing apparatus comprising a controller configured to acquire work information indicating details of work to be done on a first vehicle, and determine a first site where the work indicated by the work information is available, based on first data associating details of work that is available with each of a plurality of sites.

The present disclosure in its another aspect provides an information processing method comprising: acquiring work information indicating details of work to be done on a first vehicle; and determining a first site where the work indicated by the work information is available, based on first data associating details of work that is available with each of a plurality of sites.

Furthermore, another aspect of the present disclosure is a program for causing a computer to perform the information processing method described above, or a computer-readable storage medium storing the program non-transitorily.

According to the present disclosure, efficiency of work on a vehicle may be improved.

### BRIEF DESCRIPTION OF THE DRAWINGS

FIG. 1 is a diagram for describing an outline of a reservation system;

FIG. 2 is a diagram for describing configurations of a reservation server, a site server, and a user terminal;

FIG. 3A is an example of site data that is stored in the reservation server;

FIG. 3B is an example of vacancy status data that is stored in the reservation server;

FIG. 3C is an example of accessory data that is stored in the reservation server;

FIG. 4 is a flow diagram of processes corresponding to a first phase;

FIG. 5 illustrates examples of a screen that is presented by the site server;

FIG. 6 is a flow diagram of processes corresponding to a second phase;

FIG. 7A illustrates examples of a screen that is presented by the user terminal;

FIG. 7B illustrates examples of a screen that is presented by the user terminal;

FIG. 8 is an example of a check-in request that is generated by the user terminal;

FIG. 9 is a flowchart of processes that are performed in step S23;

FIG. 10 is an example of a list of maintenance sites that is transmitted to the user terminal;

FIG. 11 is an example of reservation data that is generated by the reservation server;

FIG. 12 is a diagram for describing a configuration of the reservation server according to a second embodiment;

FIG. 13 is an example of vehicle data according to the second embodiment;

FIG. 14 is an example of accessory data according to the second embodiment;

FIG. 15 is a flowchart of processes in step S23 according to the second embodiment;

FIG. 16 is an example of site data according to a third embodiment;

FIG. 17 is a flowchart of processes in step S23 according to the third embodiment;

FIG. 18 is an example of cost data according to the third embodiment; and

FIG. 19 is an example of a list of maintenance sites that is transmitted to the user terminal in the third embodiment.

### DESCRIPTION OF THE EMBODIMENTS

Due to recent improvements in vehicle functions, consideration is given to systems that enable equipment and functions of a vehicle to be upgraded at later timings. For example, it is becoming possible to add, at a later timing, safety equipment that is not mounted at a time of purchase of a new vehicle.

However, depending on the component to be upgraded, sites where work can be done may be limited. For example, a component closely related to a driving system of a vehicle is possibly permitted to be handled only at a factory authorized by the manufacturer.

That is, depending on a target component, confusion may be caused due to sites where work can be done and sites where work cannot be done being present.

An information processing apparatus according to the present disclosure solves such a problem.

An information processing apparatus according to a first aspect of the present disclosure includes a controller configured to acquire work information indicating details of work to be done on a first vehicle, and determine a first site where the work indicated by the work information is available, based on first data associating details of work that is available with each of a plurality of sites.

Work to be done on the first vehicle includes, in addition to maintenance work, replacement, addition, upgrade, removal and the like of components. Target components include not only hardware but also software.

The work information is information indicating specific details of work. For example, the work information may include type of work, information for identifying a target component, and the like. For example, as the type of work, inspection, replacement of a consumable item, installation, uninstallation or upgrade of software, installation or removable of hardware, and the like may be cited.

The work information may be transmitted from an external apparatus, together with information requesting work on a vehicle.

The first data is data indicating details of work that can be done at each of a plurality of sites. The controller determines the site where work specified for the first vehicle can be done, based on the work information and the first data.

According to such a configuration, a site where desired work can be done may be swiftly determined from a plurality of sites.

In the following, specific embodiments of the present disclosure will be described with reference to the drawings. A hardware configuration, a module configuration, a functional configuration, and the like described in each embodiment are not intended to limit the technical scope of the present disclosure unless stated otherwise.

### First Embodiment

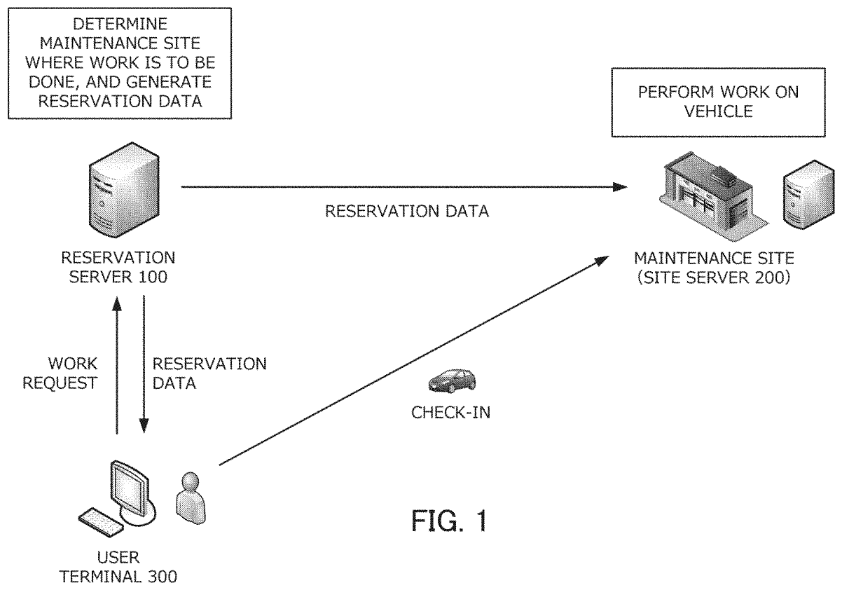

An outline of a reservation system according to a first embodiment will be described with reference to FIG. 1.

The reservation system according to the present embodiment includes a reservation server 100 that manages a plurality of maintenance sites, at least one site server 200 corresponding to each maintenance site, and at least one user terminal 300.

A maintenance site is a site where predetermined work can be done on a vehicle (such as a maintenance factory). In the present embodiment, predetermined work includes work of adding, replacing or upgrading a component in a vehicle. A component may be a hardware component or a software component. Furthermore, the hardware component may be an on-board device or an interior item.

In the present specification, a component that is a target of work will be referred to as “accessory”.

As an example of the on-board device, there may be cited an electronic control unit of a vehicle. A new function may be added to a vehicle by adding or upgrading an on-board device. For example, an advanced safety system (autonomous emergency braking, an unintended acceleration mitigation system, an adaptive cruise control system, a lane departure prevention system, a rear vehicle monitoring system, an automatic headlamp beam switching system, or the like) may be added to a vehicle.

Furthermore, examples of the interior item include a seat, a sunroof, and a rear-view mirror, for example. A new value may be added to a vehicle by adding or upgrading an interior item. Upgrade of an interior item may be change to a genuine leather seat, change to a power seat, addition of a steering wheel heater, addition of a seat heater, or change to a digital mirror, for example.

The reservation server 100 is an apparatus that manages a plurality of maintenance sites. The reservation server 100 makes a reservation for work to be done on a predetermined vehicle, based on a request (hereinafter “work request”) transmitted from the user terminal 300. The reservation server 100 manages details of work that is available in relation to each maintenance site, and is capable of determining the maintenance site where a vehicle is to be checked in, based on the details of work requested by the work request. Data about a reservation (hereinafter “reservation data”) generated by the reservation server 100 is transmitted to the site server 200 and the user terminal 300.

The site server 200 is a server apparatus that is associated with a maintenance site where a vehicle is to be worked on. A maintenance site is a manufacturing factory or a maintenance factory for vehicles, a car dealership, or the like, for example. The site server 200 receives a vehicle based on an instruction from the reservation server 100, and performs work on the vehicle.

The user terminal 300 is a computer that is associated with a user. A user may access the reservation server 100 via the user terminal 300 and make a reservation for work. Note that the user terminal 300 may be a computer owned by an owner of a vehicle, or may be a computer that is installed at a store of a business operator (for example, a car dealership).

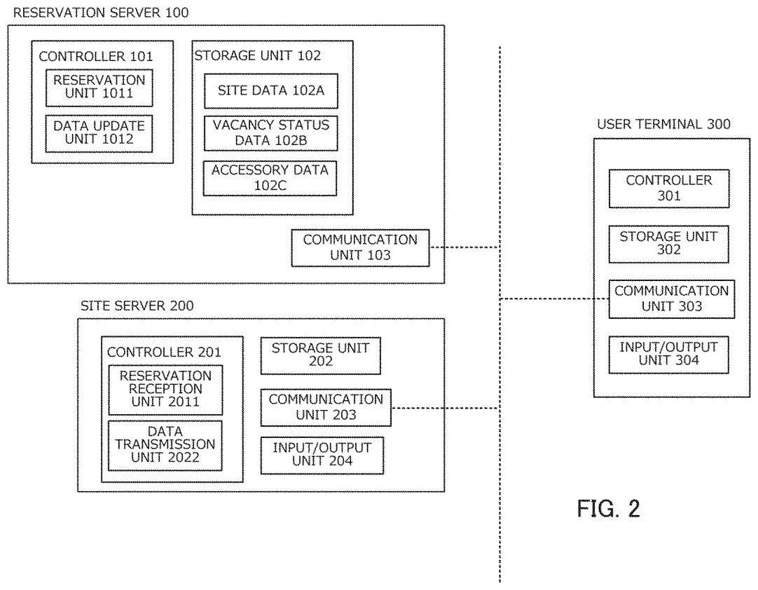

FIG. 2 is a diagram illustrating, in greater detail, structural elements of the reservation server 100, the site server 200, and the user terminal 300 that are included in the reservation system according to the present embodiment. First, a description of the user terminal 300 will be given.

For example, the user terminal 300 is a computer, such as a personal computer, a smartphone, a mobile phone, a tablet computer, or a personal digital assistant. The user terminal 300 includes a controller 301, a storage unit 302, a communication unit 303, and an input/output unit 304.

The controller 301 is an arithmetic device in charge of control performed by the user terminal 300. The controller 301 may be implemented by an arithmetic processing device such as a central processing unit (CPU).

The controller 301 executes a function of accessing and interacting with the reservation server 100. This function may be implemented by a web browser running on the user terminal 300, or by dedicated application software.

The storage unit 302 includes a main memory and an auxiliary memory. The main memory is a memory where programs to be executed by the controller 301, and data to be used by the control programs are developed. The auxiliary memory is a device where programs to be executed by the controller 301, and data to be used by the control programs are stored. Programs to be executed by the controller 301 may be packaged as applications and be stored in the auxiliary memory. Furthermore, an operating system for executing these applications may also be stored. Processes described below are performed by the programs stored in the auxiliary memory being loaded into the main memory and executed by the controller 301.

The main memory may include a random access memory (RAM) and a read only memory (ROM). The auxiliary memory may include an erasable programmable ROM (EPROM) and a hard disk drive (HDD). The auxiliary memory may further include a removable medium, or in other words, a removable recording medium.

The communication unit 303 is a wireless communication interface for connecting the user terminal 300 to a network. The communication unit 303 is capable of communicating with the reservation server 100 via a wireless LAN or a mobile communication service such as 3G, LTE or 5G, for example.

The input/output unit 304 is a unit that receives an input operation performed by a user, and that presents information to the user. For example, the input/output unit 304 is a touch panel display. The input/output unit 304 may alternatively include a liquid crystal display and a control unit thereof, or a touch panel and a control unit thereof.

Next, a description will be given of the reservation server 100.

The reservation server 100 manages a database for managing a plurality of maintenance sites, and selects a maintenance site where specified work can be done and generates reservation data in a case where a work request is transmitted from the user terminal 300.

The reservation server 100 is also capable of updating the database based on data transmitted from the site server 200.

In the present embodiment, the reservation server 100 may be capable of executing a web server for performing interaction with the site server 200 and the user terminal 300. In this case, for example, the site server 200 and the user terminal 300 may input/output information by accessing a web service using a browser. The reservation server 100 may also provide services through means other than the web server. For example, a service for interaction with dedicated application software installed in the site server 200 or the user terminal 300 through a predetermined protocol may be executed on the reservation server 100.

The reservation server 100 may be a general-purpose computer. That is, the reservation server 100 may be a computer including processors such as a CPU and a GPU, main memories such as a RAM and a ROM, and auxiliary memories such as an EPROM, a hard disk drive and a removable medium. An operating system (OS), various programs, various tables, and the like are stored in the auxiliary memory, and a function matching a predetermined object as described below may be implemented by loading a program stored in the auxiliary memory into a work area in the main memory and by executing the same, and by each structural unit or the like being controlled through execution of the program. Note that one or some or all of functions may alternatively be implemented by a hardware circuit such as an ASIC or an FPGA.

The reservation server 100 includes a controller 101, a storage unit 102, and a communication unit 103.

The controller 101 is an arithmetic device in charge of control performed by the reservation server 100. The controller 101 may be implemented by an arithmetic processing device such as a CPU.

The controller 101 includes two functional modules, namely, a reservation unit 1011 and a data update unit 1012. Each functional module may be implemented by the CPU executing a stored program.

The reservation unit 1011 makes a reservation for a maintenance site where work is to be done on a vehicle, based on a work request received from the user terminal 300. Specifically, a search is performed in the database based on the work information included in the work request, and a process of selecting a maintenance site where specified work can be done, and a process of generating data (reservation data) for reserving the selected maintenance site are performed.

In the present embodiment, the reservation unit 1011 determines the maintenance site where work is to be done, by referring to the following data stored in the database.

### (1) Site Data

Site data is data unique to each maintenance site being managed. The site data defines details of work that can be done at each maintenance site.

### (2) Vacancy Status Data

Vacancy status data is data storing the status of reservation vacancy for each maintenance site.

### (3) Accessory Data

Accessory data is data storing a selling price of an accessory, an installation fee, a required work time, and the like.

These data pieces are stored in the storage unit 102 as site data 102A, vacancy status data 102B, and accessory data 102C, respectively.

The data update unit 1012 updates the three types of data described above based on data received from the site server 200.

The storage unit 102 includes a main memory and an auxiliary memory. The main memory is a memory where programs to be executed by the controller 101, and data to be used by the control programs are developed. The auxiliary memory is a device where programs to be executed by the controller 101, and data to be used by the control programs are stored.

Furthermore, the storage unit 102 stores the site data 102A, the vacancy status data 102B, and the accessory data 102C described above.

The site data 102A is data unique to each maintenance site being managed.

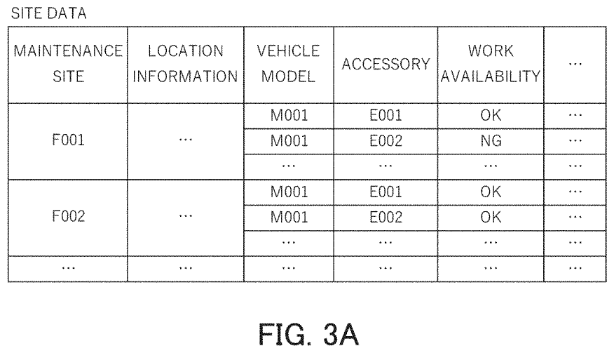

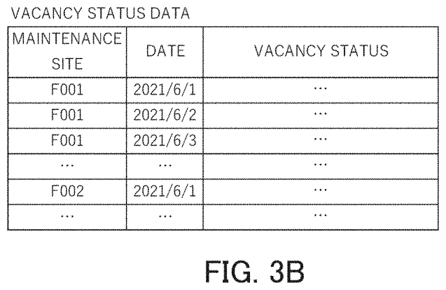

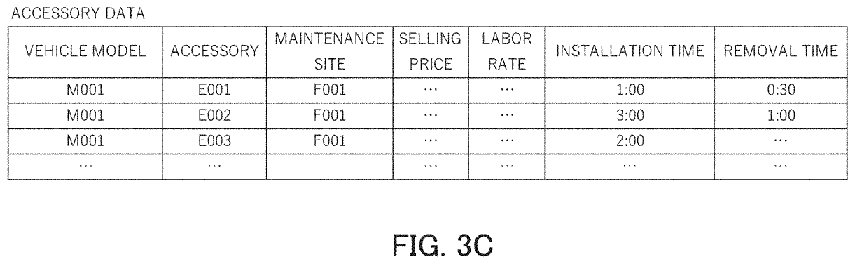

FIG. 3A is an example of the site data 102A. As illustrated, the site data 102A includes identifiers and position information of a plurality of maintenance sites. Furthermore, the site data 102A stores, for each maintenance site, a combination of vehicle model and accessory, and availability of work for the combination. For example, in the illustrated example, it is defined that, at a maintenance site “F001”, work can be done on a combination of vehicle model “M001” and accessory “E001” but not on a combination of vehicle model “M001” and accessory “E002”.

By referring to the site data 102A, a maintenance site where work regarding a predetermined accessory can be performed on a predetermined vehicle model may be retrieved.

In the present specification, the vehicle model is defined based on a vehicle type, a model year, and grade.

The vacancy status data 102B is data indicating date/time when there is a reservation vacancy at a maintenance site. By referring to the vacancy status data 102B, date/time when work can be done may be identified. FIG. 3B illustrates an example of the vacancy status data 102B.

The vacancy status data 102B stores data about the vacancy status for each maintenance site and each date. For example, data about the vacancy status may include a timetable or the like of each facility (pit) or maintenance worker. For example, information about the vacancy status is transmitted as appropriate by staff at the maintenance site, via the site server 200, and is updated.

The accessory data 102C is data about accessories that can be mounted in a vehicle.

FIG. 3C illustrates an example of the accessory data 102C. The accessory data 102C stores data about a combination of vehicle model and accessory, a selling price of an accessory, a labor rate, a required installation time, a required removal time, and the like. By referring to the accessory data 102C, a cost of work and a required time for the work may be acquired.

Each data piece described above may be constructed by data stored in a memory being managed by a program of a database management system (DBMS) executed by the processor. In this case, each data piece may be a relational database, for example.

The communication unit 103 is a communication interface for connecting the reservation server 100 to a network. For example, the communication unit 103 includes a network interface board, or a wireless communication interface for wireless communication.

Next, a description will be given of the site server 200.

The site server 200 is an apparatus installed at a maintenance site where a vehicle is to be worked on. The site server 200 acquires reservation data transmitted from the reservation server 100. Furthermore, the site server 200 transmits data about work (for example, data about availability of work for each accessory, data about the status of reservation vacancy, and the like) to the reservation server 100.

Like the reservation server 100, the site server 200 may be a general-purpose computer. That is, the site server 200 may be a computer including processors such as a CPU and a GPU, main memories such as a RAM and a ROM, and auxiliary memories such as an EPROM, a hard disk drive, and a removable medium.

The site server 200 includes a controller 201, a storage unit 202, a communication unit 203, and an input/output unit 204.

The controller 201 is an arithmetic device in charge of control performed by the site server 200. The controller 201 may be implemented by an arithmetic processing device such as a CPU.

The controller 201 includes two functional modules, namely, a reservation reception unit 2011 and a data transmission unit 2012. Each functional module may be implemented by the CPU executing a stored program.

The reservation reception unit 2011 acquires the reservation data from the reservation server 100, and provides the same to staff at the maintenance site.

The data transmission unit 2012 acquires the following information based on an input performed by staff at the maintenance site, and transmits the same to the reservation server 100.

(1) Information indicating availability or unavailability of work for each vehicle model and accessory (first information).
(2) Information indicating the status of reservation vacancy (second information).
(3) Information indicating a price and a labor fee for each accessory (third information).

The site data 102A in the reservation server 100 is updated by the first information. Likewise, the vacancy status data 102B is updated by the second information. Furthermore, the accessory data 102C is updated by the third information. In the following, the first to third information pieces will be collectively referred to as site information.

The storage unit 202 includes a main memory and an auxiliary memory. The main memory is a memory where programs to be executed by the controller 201, and data to be used by the control programs are developed. The auxiliary memory is a device where programs to be executed by the controller 201, and data to be used by the control programs (including the site information described above) are stored.

The communication unit 203 is a communication interface for connecting the site server 200 to a network. For example, the communication unit 203 includes a network interface board, or a wireless communication interface for wireless communication.

The input/output unit 204 is a unit that receives an input operation performed by a user, and that presents information to the user. For example, the input/output unit 204 may include an interface to an external display, a keyboard, a mouse and the like.

Note that configurations illustrated in FIG. 2 are examples, and one or some or all of the illustrated functions may alternatively be implemented by a dedicated circuit. Furthermore, programs may be stored and executed by a combination of main memory and auxiliary memory other than those illustrated.

Next, a description will be given of details of processes performed by each apparatus included in the reservation system.

Processes performed by each apparatus are roughly divided into a phase in which the site server 200 transmits the site information to the reservation server 100 and the database in the reservation server 100 is updated, and a phase in which a reservation is made for a maintenance site based on a request transmitted from the user terminal 300. The former will be referred to as a first phase, and the latter as a second phase.

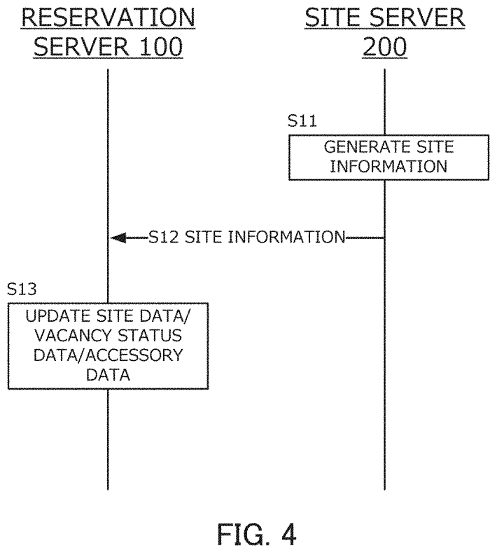

FIG. 4 is a flow illustrating processes that are performed in the first phase. The processes illustrated in FIG. 4 are started upon a request from staff operating the site server 200.

First, in step S1l, the site server 200 (the data transmission unit 2012) generates the site information. The site information may be acquired via three types of screens described below, for example.

(1) A first screen for inputting availability of work for each vehicle model and accessory.
(2) A second screen for inputting the status of reservation vacancy.
(3) A third screen for inputting a price and a labor fee for an accessory.

The first information, the second information, and the third information may be acquired through the first screen, the second screen, and the third screen, respectively.

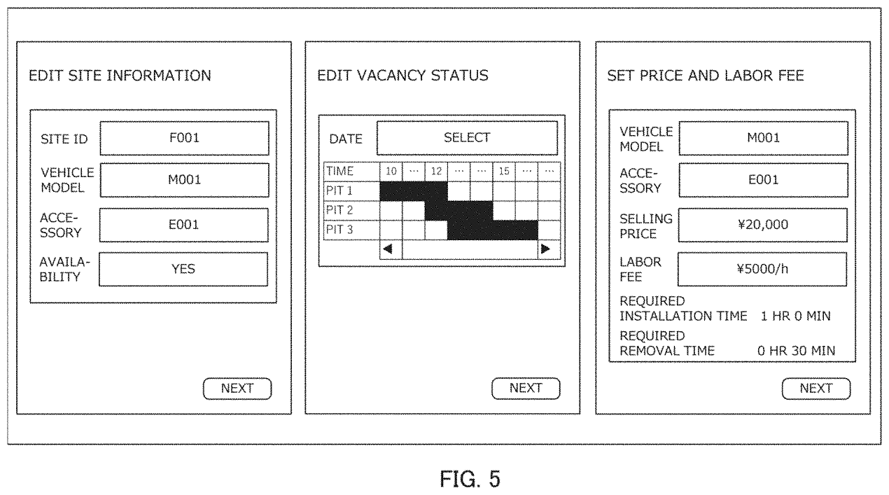

FIG. 5 is an example of screens for inputting these information pieces. In the present embodiment, the site information includes the first information, the second information, and the third information, but the site information does not necessarily have to include all of the three types of information described above. For example, it suffices if the site information includes at least one of the three types of information described above.

In step S12, the data transmission unit 2012 transmits, to the reservation server 100, the site information that is generated based on input information.

In step S13, the reservation server 100 (the data update unit 1012) updates the database based on the received site information. Specifically, in the case where the site information includes information about whether an accessory is handled (the first information), the data update unit 1012 updates the site data 102A. In the case where the site information includes information about the status of reservation vacancy (the second information), the data update unit 1012 updates the vacancy status data 102B. Furthermore, in the case where the site information includes information about a price and a labor fee for an accessory (the third information), the data update unit 1012 updates the accessory data 102C.

In the present example, the site data 102A is updated based on a report from the maintenance site, but whether an accessory can be handled or not may alternatively be set by a system administrator. For example, handling of a safety-related accessory, such as an advanced safety system, is possibly permitted only at a maintenance site related to a vehicle manufacturer or a maintenance site authorized by the vehicle manufacturer. In this case, transmission of the first information from the site server 200 may be restricted.

Next, a description will be given of processes that are performed in the second phase.

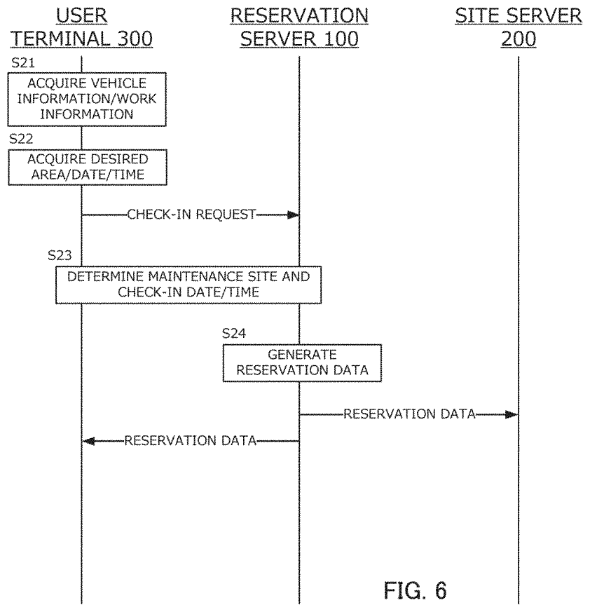

FIG. 6 is a flow illustrating processes that are performed in the second phase. The processes illustrated in FIG. 6 are started by operation of the user terminal 300.

First, in step S21, the controller 301 acquires information (hereinafter “vehicle information”) for identifying the vehicle model of a vehicle to be worked on (hereinafter “target vehicle”), and information (hereinafter “work information”) for specifying details of work.

The vehicle information is information for identifying the model, the model year, the grade, and the like of a vehicle, and a vehicle identification number (VIN), a chassis number, or a frame number may be used therefor, for example.

The work information is information for specifying the type of work and a target accessory. Types of work may include the following.
Installation of hardware (purchased)
Installation of hardware (carry-in)
Replacement of hardware (purchased)
Replacement of hardware (carry-in)
Removal of hardware
Installation of software
Uninstallation of software
Upgrade of software

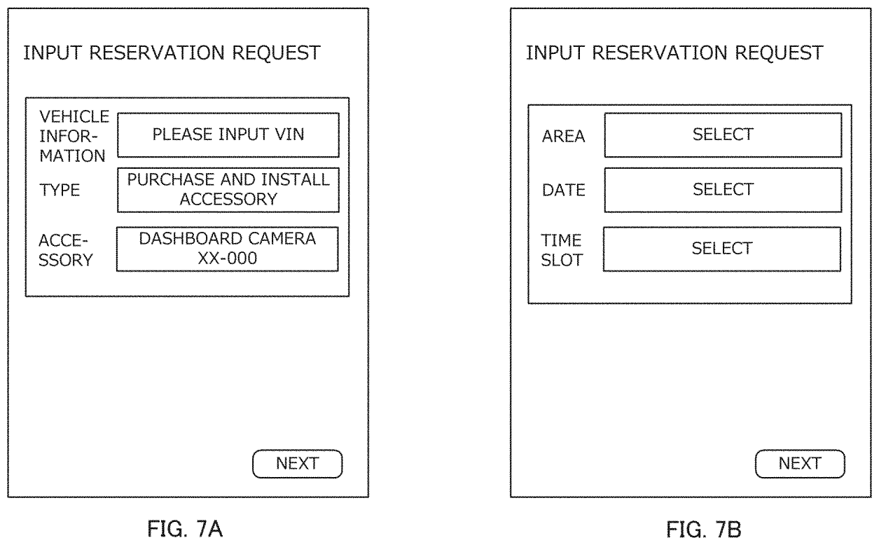

FIG. 7A is an example of a user interface screen for acquiring the vehicle information and the work information.

Next, in step S22, specification of a desired area for work and desired date/time for check-in is acquired. FIG. 7B is an example of a user interface screen for specifying the area and the date/time. Here, one of a plurality of divided areas obtained in advance is specified as the area. A time slot may be specified as the time.

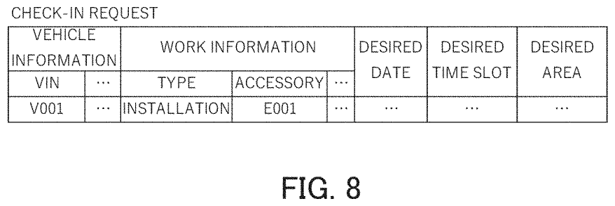

When acquisition of these information pieces is complete, the controller 301 generates a check-in request, and transmits the same to the reservation server 100. FIG. 8 is an example of the check-in request. As illustrated, the check-in request includes the vehicle information, the work information, a desired check-in date/time, information about a desired area, and the like. The check-in request is received by the reservation unit 1011.

Next, in step S23, the reservation unit 1011 determines the maintenance site where work is to be done and a check-in date/time based on the check-in request that is acquired.

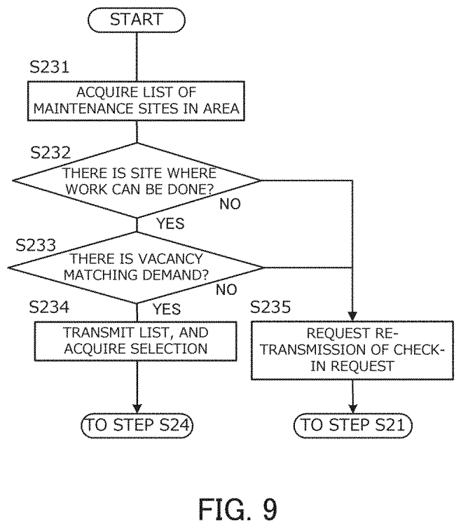

FIG. 9 is a flowchart for describing, in detail, processes that are performed by the reservation server 100 (the reservation unit 1011) in step S23.

First, in step S231, the site data 102A is referred to, and a list of a plurality of maintenance sites included in the desired area is acquired.

Next, in step S232, whether or not a maintenance site where specified work can be done is included in the acquired list is determined. Specifically, the vehicle model is identified from the vehicle information included in the check-in request, and the type of work and the accessory are identified from the work information included in the check-in request. Then, a maintenance site where work can be done on the combination of the vehicle model and the accessory is retrieved from the list.

Here, in the case where there is a maintenance site where work can be done, the process proceeds to step S233. In the case where there is no maintenance site where work can be done, the process proceeds to step S235.

In the case where the vehicle information does not include information for directly identifying the vehicle model, the vehicle model may be identified using other data sources. For example, in the case where the vehicle information is VIN, an external database, or the like linking VINs and vehicle models may be accessed to identify the vehicle model.

In step S233, the vacancy status data 102B is referred to, and reservation vacancy at the identified maintenance site is checked. Here, in the case where there is a time slot that satisfies the desired check-in date/time included in the check-in request, the process proceeds to step S234. In the case where there is no time slot that satisfies the desired check-in date/time, the process proceeds to step S235.

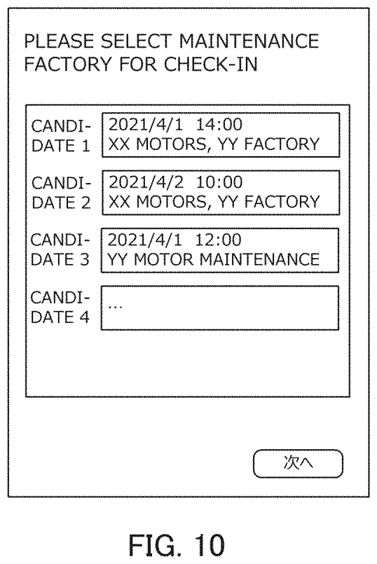

In step S234, a list of maintenance sites where the vehicle can be checked in is transmitted to the user terminal 300 so that one of the maintenance sites is selected. The list may include, in association with the maintenance sites, names, locations, dates/times when check-in can be performed, and the like. FIG. 10 is an example of the list that is presented by the user terminal 300. Furthermore, in the case where an end time of work is known, date/time when checkout of the vehicle is possible may also be presented at the same time.

In the case where the labor fees and the selling prices of accessories are different among the maintenance sites, information about the price and the labor fee may be extracted from the accessory data 102C and be presented in the present step. In this case, a total cost may be presented in relation to each maintenance site.

Furthermore, it is also possible to acquire conditions regarding the cost (the selling price of an accessory, the labor fee, the total cost, and the like) from the user terminal 300 in advance, and to list only the maintenance sites matching the conditions.

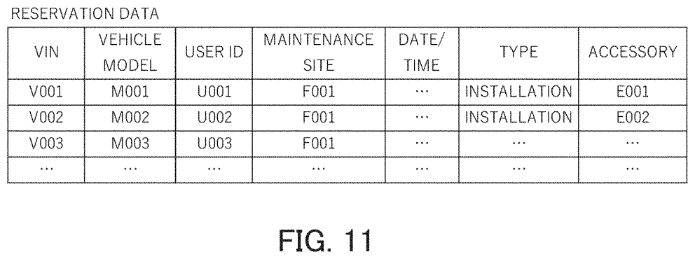

In the case where the maintenance site where work is to be done is selected in step S234, the process proceeds to step S24, and the reservation server 100 generates the reservation data. FIG. 11 is an example of the reservation data that is generated. The reservation data includes an identifier of a vehicle, a vehicle model, an identifier of a user, a maintenance site, check-in date/time, type of work, information about an accessory, and the like.

The reservation data that is generated is transmitted to the site server 200, and is processed by the reservation reception unit 2011. The reservation data is also transmitted to the user terminal 300 at the same time. Accordingly, the user may be notified of completion of reservation.

In the case where the process proceeds to step S235, a notification indicating that there is no maintenance site that satisfies the request is transmitted to the user terminal 300 to encourage input to be performed again. In this case, the process proceeds to step S21, and input is performed again by the user.

As described above, with the reservation system according to the first embodiment, the reservation server 100 stores a database that manages, for a plurality of maintenance sites, information about an accessory that can be handled, and reception of a reservation for work is performed based on the database. A user may thereby search for a site where work can be done and make a reservation for the work simply by accessing the reservation server 100.

### Second Embodiment

An accessory to be mounted in a vehicle may sometimes conflict with an accessory that is already used. For example, in the case where an electronic control unit provided by a third party other than the vehicle manufacturer is mounted in the target vehicle, erroneous operation may be caused due to occurrence of a conflict with an accessory that is newly added. A second embodiment is an embodiment for coping with such a situation, and is for determining whether work can be done or not, based on an accessory that is already used in the target vehicle.

In the second embodiment, the reservation server 100 acquires information about an accessory that is currently used in the target vehicle, and determines whether work can be done or not, based on the information. Information about an accessory that is currently used in the target vehicle may include the following, for example.

(1) Information about an accessory that is optionally mounted at a time of purchase of a new vehicle.
(2) Information about an accessory that was added in the past at a maintenance site.

In the second embodiment, the reservation server 100 holds data about such accessories for each vehicle, and determines whether work can be done or not, when a work request is received.

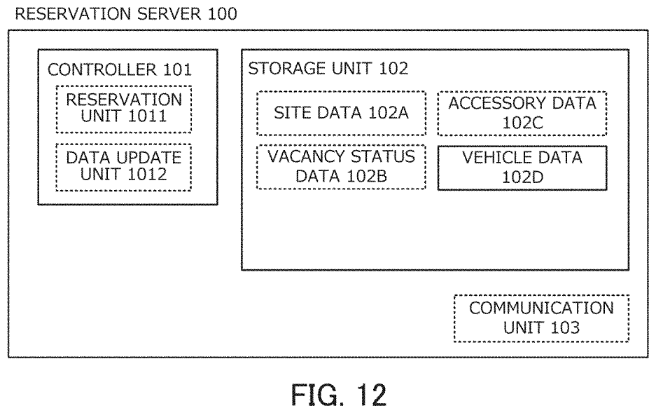

FIG. 12 is a schematic diagram of the reservation server 100 according to the second embodiment. As illustrated, in the second embodiment, the reservation server 100 further stores vehicle data 102D. The vehicle data 102D is data indicating a history of addition, removal, and the like of accessories to/from a vehicle.

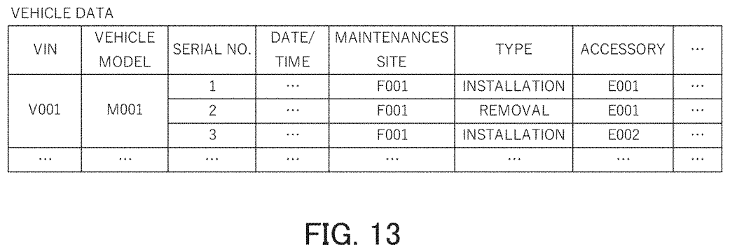

FIG. 13 is an example of the vehicle data 102D. As illustrated, the vehicle data 102D includes an identifier of a vehicle, the vehicle model, date/time when work was performed, the maintenance site where work was done, type of work, information about an accessory, and the like. The reservation server 100 may determine the accessories currently used in the target vehicle by referring to the vehicle data 102D.

The vehicle data 102D may be updated by the data update unit 1012 based on information transmitted from the site server 200. For example, in the case where requested work on a predetermined vehicle is completed, the site server 200 may transmit information about details of the work and the accessory (hereinafter “conducted work information”) to the reservation server 100, and the reservation server 100 (the data update unit 1012) may update the vehicle data 102D based on the conducted work information.

The conducted work information does not necessarily have to be transmitted from the site server 200. For example, in the case where an accessory is optionally mounted at the time of purchase of a new vehicle, a manufacturing factory of the vehicle may generate the conducted work information, and transmit the same to the reservation server 100. In the case where an accessory is added by the owner of the vehicle himself/herself, for example, the user terminal 300 may generate the conducted work information, and transmit the same to the reservation server 100.

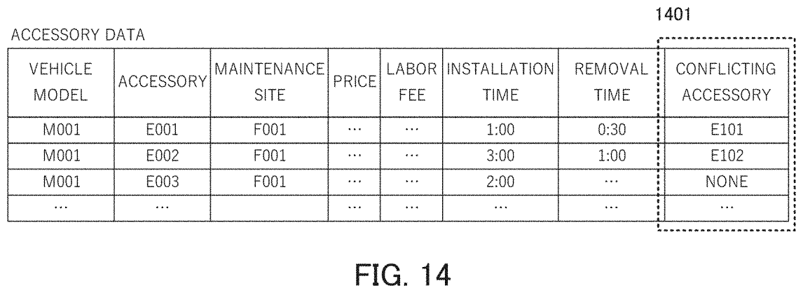

Furthermore, in the second embodiment, the reservation server 100 holds information about conflicts between accessories. FIG. 14 is an example of the accessory data 102C according to the second embodiment. As illustrated, the accessory data 102C according to the second embodiment includes a field (a reference sign 1401) where information about a conflicting accessory is stored.

In the illustrated example, it is indicated that, in a case where an accessory “E101” is currently mounted in a vehicle model “M001”, there is a conflict with a new accessory “E001”.

A conflict means that an accessory cannot be added physically, that normal operation cannot be expected, or that safety cannot be guaranteed, for example. In the case where there is a conflict, the reservation unit 1011 determines that work cannot be done on the target vehicle.

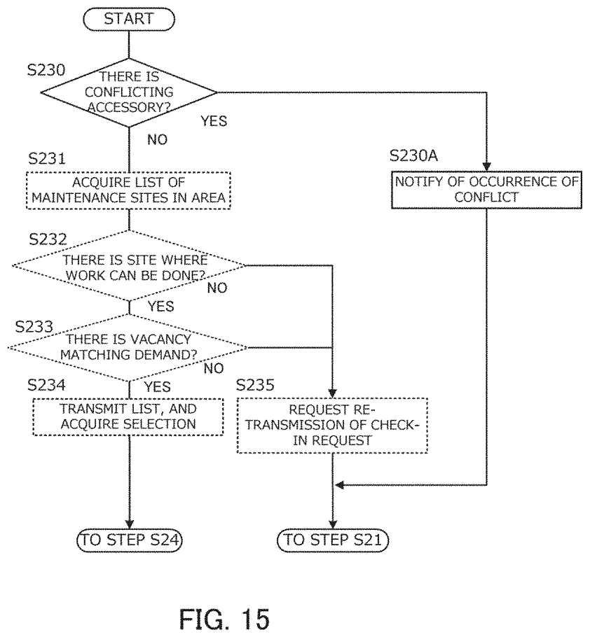

FIG. 15 is a flowchart of processes that are performed by the reservation server 100 in the second embodiment. In the second embodiment, in step S230, the reservation unit 1011 determines presence or absence of a conflicting accessory. Specifically, first, whether there is a conflicting accessory or not is determined based on the work information included in the work request and the accessory data 102C. Then, the vehicle data 102D is referred to, and whether the conflicting accessory is mounted in the target vehicle or not is determined. Here, in the case where the conflicting accessory is mounted in the target vehicle, the process proceeds to step S230A. In the case where the conflicting accessory is not mounted in the target vehicle, the process proceeds to step S231.

In step S230A, the reservation unit 1011 notifies the user terminal 300 that the work cannot be done.

According to the second embodiment, whether a new accessory can be added or not may be determined based on the accessory that is currently used in the target vehicle.

In the example in FIG. 14, a conflicting accessory is specified based on the identifier, but the conflicting accessory may alternatively be specified based on the manufacturer or the like. For example, in the case where an accessory made by a manufacturer (a third party) different from that of an authentic product used by the vehicle manufacturer is mounted, or in the case where an accessory not authorized by the vehicle manufacturer is mounted, occurrence of a conflict may be determined. For this purpose, the vehicle data 102D may include the manufacturer of an accessory, and data indicating whether authorization is given or not.

In the present embodiment, the vehicle data 102D is stored in the reservation server 100, but the data about accessories mounted in a vehicle may be provided by an external apparatus. For example, the reservation server 100 may acquire a record of maintenance of the target vehicle from the external apparatus, and may determine accessories currently used in the target vehicle based on the record of maintenance.

The data about accessories mounted in the target vehicle may be included in the work request.

Moreover, in the present embodiment, in the case where there is occurrence of a conflict, it is determined that work cannot be done, but a reservation for work may be accepted under predetermined conditions (for example, in a case where the user consents to non-application of warranty).

### Third Embodiment

In the first and second embodiments, the user has to bring the vehicle to a maintenance site that is determined by the reservation server 100. However, some maintenance sites do not expect visits from clients. Accordingly, in a third embodiment, a vehicle is received at a site where clients can be treated, such as a car dealership, and the received vehicle is transported.

In the third embodiment, the reservation server 100 determines the maintenance site, and also determines a site as a reception (hereinafter “reception site”) where the target vehicle is to be received. The reception site may be a store where vehicles are sold, such as a car dealership, or a maintenance factory where the vehicle is not worked on, for example.

In the third embodiment, a business operator that is to work on a vehicle receives the vehicle at the reception site, and transports the vehicle to a maintenance site where work is to be done. An end user may thus receive services without traveling to and from a maintenance site at a remote location.

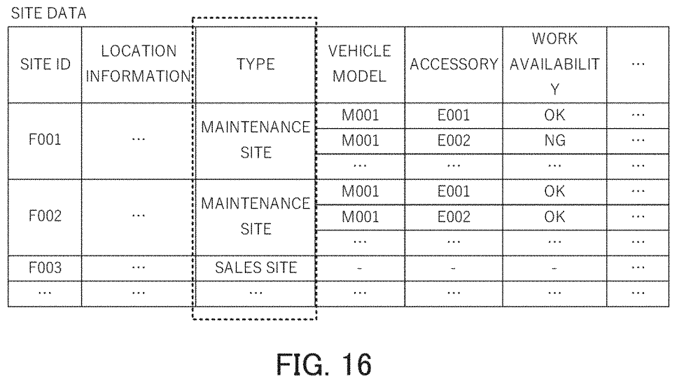

FIG. 16 is an example of the site data 102A according to the third embodiment. As illustrated, in the third embodiment, type is associated with a plurality of sites. In the illustrated example, the maintenance site is the site where a vehicle is to be worked on. A sales site is a site where vehicles are sold. Note that other sites may be defined as long as handing-over of a vehicle is possible. For example, a parking lot where a vehicle is handed over without presence of people may be taken as a site.

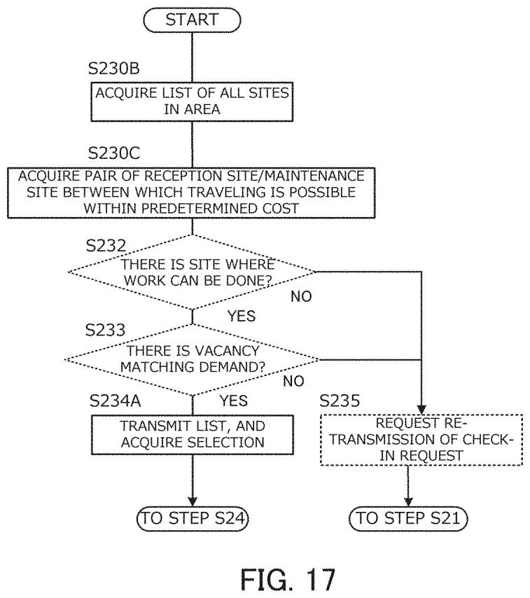

FIG. 17 is a flowchart of processes that are performed by the reservation server 100 in the third embodiment. Processes the same as those in the first embodiment are indicated by dotted lines, and detailed description thereof is omitted.

First, in step S230B, the reservation unit 1011 acquires all the sites (maintenance sites, sales sites, or other sites) that are present in an area specified by a work request.

Next, in step S230C, the reservation unit 1011 determines a pair of reception site and maintenance site between which traveling can be performed within a predetermined cost.

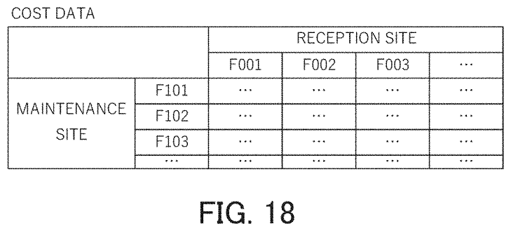

In the present embodiment, the storage unit 102 stores data (cost data) about a movement cost between sites. FIG. 18 is an example of the cost data. The cost data is data recording a cost that occurs at the time of movement between the reception site and the maintenance site. As the cost, a required time, a distance, and a financial cost may be cited, for example.

In the present step, at least one pair of sites between which traveling can be performed by a vehicle within a predetermined cost (such as within one hour) is generated.

The reservation unit 1011 performs the processes in steps S232 and S233 for each pair, and generates a pair of reception site and maintenance site that can be used.

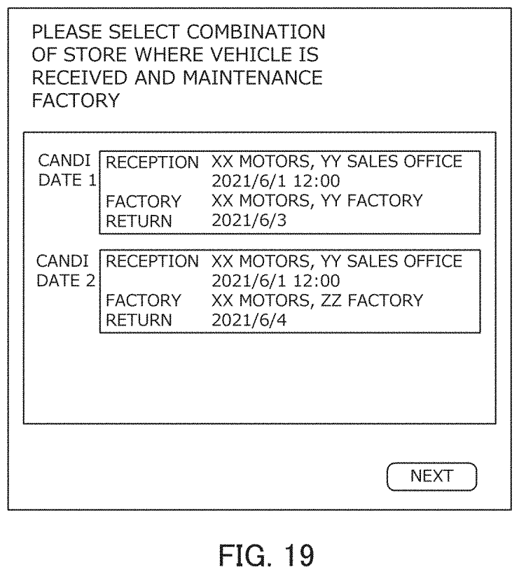

In step S234A, a list including pairs of reception site and maintenance site is transmitted to the user terminal 300 so that one of the pairs is selected. FIG. 19 is an example of the list.

In the case of presenting the list to staff of a business operator providing the service or the like instead of the end user, information about the cost may be output at the same time. A pair of sites with a lower cost may thus be selected.

As described above, in the third embodiment, the reception site where a vehicle is to be received is determined separately from the maintenance site. Convenience of the user may thus be increased. Furthermore, a pair of reception site and maintenance site that satisfies predetermined cost conditions is generated. A good balance may thus be achieved between cost and convenience.

In the third embodiment, a pair of reception site and maintenance site is determined, but it is also possible to additionally determine the reception site only in a case where a determined maintenance site does not directly deal with clients.

Moreover, in the third embodiment, a pair of reception site and maintenance site is determined based on the movement cost for a vehicle, but the pair of reception site and maintenance site may be determined by taking other costs into account and based on a total cost.

(Modification)

The aforementioned embodiments are merely illustrative, and the present disclosure may be implemented with appropriate changes without departing from its spirit.

For example, the processing and units described in the present disclosure may be implemented in any combination as long as no technical inconsistency occurs.

In addition, the processing described as being performed by one device may be shared and executed by a plurality of devices. Alternatively, the processing described as being performed by different devices may be executed by one device. In a computer system, what hardware configuration (server configuration) realizes each function can be flexibly changed.

The present disclosure can also be realized by supplying a computer program including the functions described in the above embodiments to a computer and causing one or more processors included in the computer to read and execute the program. Such a computer program may be provided to the computer by a non-transitory computer-readable storage medium connectable to a system bus of the computer, or may be provided to the computer via a network. Examples of non-transitory computer readable storage media include: any type of disk such as a magnetic disk (floppy (registered trademark) disk, hard disk drive (HDD), etc.), an optical disk (CD-ROM, DVD disk, Blu-ray disk, etc.); and any type of medium suitable for storing electronic instructions, such as read-only memory (ROM), random access memory (RAM), EPROM, EEPROM, magnetic cards, flash memory, and optical cards.

What is claimed is:

1. An information processing apparatus comprising a controller configured to
acquire work information indicating details of work to be done on a first vehicle, and
determine a first site where the work indicated by the work information is available, based on first data associating details of work that is available with each of a plurality of sites.

2. The information processing apparatus according to claim 1, wherein
the controller extracts, from the first data, the first site where work that is specified for the first vehicle is available, in a case where a request including the work information is acquired.

3. The information processing apparatus according to claim 2, wherein
the request further includes vehicle information for identifying the first vehicle.

4. The information processing apparatus according to claim 3, wherein
the first data is data associating details of work that is available for a vehicle having a predetermined attribute, with each of the plurality of sites, and
the controller extracts the first site from the first data by further using the vehicle information.

5. The information processing apparatus according to claim 4, wherein
the vehicle information includes data about a model and a model year of the first vehicle.

6. The information processing apparatus according to claim 3, wherein
the controller further acquires information about an accessory that is currently mounted in the first vehicle, and
whether the work that is specified for the first vehicle is available or not is further determined based on the accessory.

7. The information processing apparatus according to claim 6, wherein
the controller performs the determination based on second data associating presence or absence of the accessory with availability or unavailability of work at the plurality of sites.

8. The information processing apparatus according to claim 1, wherein
the details of the work indicated by the work information includes addition or replacement of a vehicle component.

9. The information processing apparatus according to claim 1, wherein
in a case where the details of the work indicated by the work information is addition of safety equipment, the controller determines the first site that is related to a manufacturer of the first vehicle.

10. The information processing apparatus according to claim 1, wherein
the controller further determines a second site where handing-over of the first vehicle is performed.

11. The information processing apparatus according to claim 10, wherein
the second site includes a sales site of the first vehicle.

12. The information processing apparatus according to claim 11, wherein
the controller determines a combination of the first site and the second site taking into account a transport cost for the first vehicle between the first site and the second site.

13. The information processing apparatus according to claim 1, wherein
in a case where the work to be done on the first vehicle is available at a plurality of the first sites, the controller calculates a cost of target work for each of the plurality of first sites.

14. The information processing apparatus according to claim 1, wherein
the controller generates reservation data for reserving the first site that is determined.

15. The information processing apparatus according to claim 14, wherein
the reservation data includes information about the first site, information about a target vehicle, and the details of the work.

16. An information processing method comprising:
acquiring work information indicating details of work to be done on a first vehicle; and
determining a first site where the work indicated by the work information is available, based on first data associating details of work that is available with each of a plurality of sites.

17. The information processing method according to claim 16, wherein
in a case where a request including vehicle information about the first vehicle and the work information is acquired, the first site where work that is specified for the first vehicle is available is extracted from the first data.

18. The information processing method according to claim 17, wherein
the first data is data associating details of work that is available for a vehicle having a predetermined attribute, with each of the plurality of sites, and
the first site is extracted from the first data by further using the vehicle information included in the request.

19. The information processing method according to claim 18, wherein
the vehicle information includes data about a model and a model year of the first vehicle.

20. A non-transitory computer readable storing medium recording a computer program for causing a computer to perform an information processing method according to claim 16.
